(19) United States
(12) Patent Application Publication
(10) Pub. No.: US 2025/0035766 A1
(43) Pub. Date: Jan. 30, 2025

(54) TRANSPARENT ANTENNA AND REFLECTOR FOR MILLIMETER-WAVE RADAR

(71) Applicant: Magna Electronics Inc., Auburn Hills, MI (US)

(72) Inventor: Hussein Farhat, Dearborn Heights, MI (US)

(21) Appl. No.: 18/782,400

(22) Filed: Jul. 24, 2024

Related U.S. Application Data
(60) Provisional application No. 63/528,750, filed on Jul. 25, 2023.

(51) Int. Cl. G01S 13/04; H01Q 1/12; H01Q 1/38

(52) U.S. Cl. CPC G01S 13/04; H01Q 1/1271; H01Q 1/38

(57) ABSTRACT

A vehicular radar sensing system includes a radar sensor disposed at a vehicle and that senses within an interior cabin of the vehicle. The radar sensor includes an antenna that radiates radio frequency signals within the cabin of the vehicle and that receives radio frequency signals from within the cabin of the vehicle. A printed circuit board (PCB) includes a transmitter that transmits radio frequency signals to the antenna and a receiver that receives radio frequency signals from the antenna. The radar sensor is operable to capture radar data based on the received radio frequency signals. Responsive to processing radar data captured by the radar sensor, the system determines presence of an occupant within the cabin of the vehicle. The antenna is disposed at a portion of a substrate and the portion of the substrate is at least partially transmissive of visible light incident at the portion of the substrate.

### CROSS REFERENCE TO RELATED APPLICATION

The present application claims the filing benefits of U.S. provisional application Ser. No. 63/528,750, filed Jul. 25, 2023, which is hereby incorporated herein by reference in its entirety.

### FIELD OF THE INVENTION

The present disclosure relates generally to a vehicle sensing system for a vehicle, and more particularly, to antennas for a radar sensor of the vehicle sensing system.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

Radar systems are widely used in automotive, military, and weather forecasting applications. Radar systems for automotive applications are currently deployed at millimeter-wave frequency bands (58 gigahertz to 62 gigahertz or 76 gigahertz to 81 gigahertz). Such radar systems may include integrated radar modules, which may be required to be compact and to offer high-performance operation. A common requirement for automotive radar systems is that they be usable indoor (i.e., inside the vehicle cabin), and outdoors (i.e., exterior of the vehicle).

Radar systems may include a radiator (antenna) which sends a radio-frequency (RF) signal that travels out into many different media to reach the target. One of the media is called Radom which is typically made of material transparent to RF radiation and not causing any attenuation. Another medium is the air, which can include many constituents such as humidity, dust, snow, and rain. Once the RF signal hits the target or any object in its way, it either gets absorbed, reflected, or both. The reflected signal travels back through the same air to the Radom all the way through the antenna which feeds the radar system (electronics). In case of reflectors, the process may include the feeder radiating RF signals to the reflector through the air, the signal reflects off the reflector towards target(s) which in turns reflect the signal back to the reflector then to receiving (RX) electronics on a printed circuit board (PCB).

Glass surfaces in a vehicle, such as windows and horizontal glass roofs are commonly present in areas where a radar sensor may be advantageously placed for sensing objects within the vehicle. Due to the mounting surface type (transparent glass) and to the application (in-cabin sensing), transmitting and receiving signals reflected off occupants (direct LoS) and other vital signs may require multiple systems to be integrated and mounted in a vehicle.

### SUMMARY OF THE INVENTION

A radar antenna may include a substrate of material transparent to visible light and a mesh of conductive material disposed within or upon the substrate. The radar antenna, including the substrate and the mesh of conductive material appears to be substantially transparent to a human viewer.

Optionally, the substrate includes glass or a polymer. The polymer may include Polyethylene terephthalate (PET). Optionally, the substrate includes Strontium Lanthanum Aluminate or SrLaAlO₄ (SLAO). Further, the substrate may include Lanthanum Aluminate or LaAlO₃+Sr₂AlTaO₆ (LSAT). For example, the LSAT of the substrate may include three parts of LaAlO₃ per seven parts of Sr₂AlTaO₆.

Optionally, the mesh of conductive material may be embedded within the substrate. The radar antenna may further include a waveguide configured to transmit electromagnetic radiation (e.g., radio frequency signals) to the mesh of conductive material, and the waveguide may be at least partially transparent to visible light.

The substrate may include a sunroof disposed within a roof of a vehicle. Moreover, the radar antenna may further include a transparent conductive metal (TCM) film disposed on the substrate and configured to reflect radar energy to the mesh of conductive material. The TCM film may include Perovskite oxide (SrVO₃) and/or Calcium Vanadium oxide (CaVO₃).

A radar reflector may include a substrate of material transparent to visible light and a TCM film disposed on the substrate and configured to reflect radar energy. The radar reflector, including the substrate and the TCM film, appears to be substantially transparent to a human viewer.

Optionally, the TCM film may include Perovskite oxide and/or Calcium Vanadium oxide. The substrate may include a sunroof disposed within a roof of a vehicle. Further, the substrate may include PET. Optionally, the substrate may include SLAO and/or LSAT.

For example, a vehicular radar sensing system includes a radar sensor disposed at a vehicle, the radar sensor sensing within an interior cabin of the vehicle. The radar sensor includes an antenna that radiates radio frequency signals within the interior cabin of the vehicle and that receives radio frequency signals from within the cabin of the vehicle. The radar sensor includes a printed circuit board (PCB) including electronic circuitry and associated software. The electronic circuitry includes a transmitter that transmits radio frequency signals to the antenna and a receiver that receives radio frequency signals from the antenna. The radar sensor is operable to capture radar data based on the received radio frequency signals and the PCB includes a processor operable to process radar data captured by the radar sensor. Responsive to processing radar data captured by the radar sensor, the system determines presence of an occupant within the interior cabin of the vehicle. The antenna is disposed at a portion of a substrate and the portion of the substrate including the antenna is transmissive to at least a portion of visible light incident at the portion of the substrate.

These and other objects, advantages, purposes and features of the present invention will become apparent upon review of the following specification in conjunction with the drawings.

### BRIEF DESCRIPTION OF THE DRAWINGS

Further details, features and advantages of designs of the invention result from the following description of embodiment examples in reference to the associated drawings.

FIG. 1 is an overhead view of a vehicle;

FIG. 2 is a schematic diagram of a transparent radar sensor system;

FIG. 3 is a cross-sectional diagram of a structure that transmits visible light and reflects ultraviolet (UV) and Infrared (IR) radiation;

FIGS. 4-5 are diagrams of radio waves radiating from a source and reflecting off of a reflector; and

FIG. 6 is a schematic diagram of the radar reflector.

### DESCRIPTION OF THE PREFERRED EMBODIMENTS

A vehicle sensing system and/or driver or driving assist system and/or object detection system and/or alert system operates to capture sensing data exterior of the vehicle and may process the captured data to detect objects at or near the vehicle and in the predicted path of the vehicle, such as to assist a driver of the vehicle or a control for an autonomous vehicle in maneuvering the vehicle in a forward or rearward direction. Optionally, the system may capture sensing data interior of the vehicle and may process the captured data to detect objects within the interior cabin of the vehicle, such as to detect presence of occupants within the vehicle, to detect objects in the footwell or other interior portions of the vehicle, and the like. The system includes a processor that is operable to receive sensing data from one or more sensors and provide an output, such as an alert or control of a vehicle system.

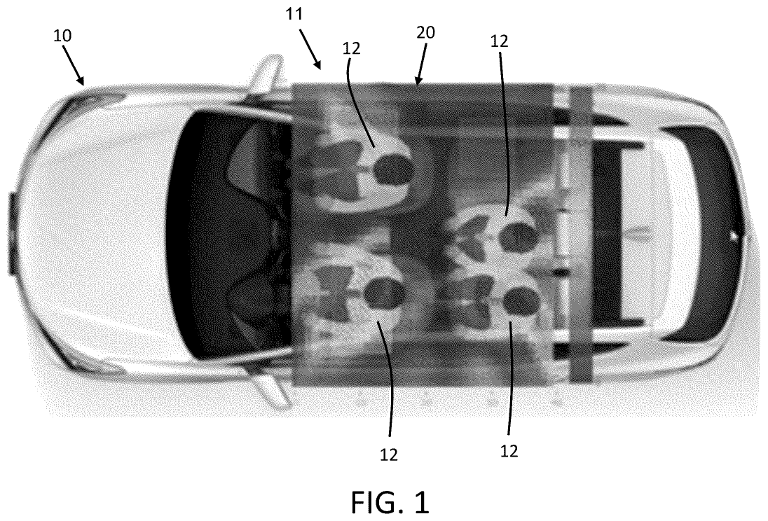

Referring now to the drawings and the illustrative embodiments depicted therein, a vehicle 10 includes a driving assistance system or sensing system 11 that includes one or more radar sensor units 20 that senses at least a portion of an interior cabin of the vehicle 10, such as for detecting presence of occupants 12 within the cabin of the vehicle 10 (FIG. 1). Optionally, the system 11 may include multiple radar sensors, such as radar sensors that sense respective portions of the interior cabin of the vehicle (e.g., a front driver-side portion of the cabin, a front passenger-side portion of the cabin, a rear seat portion of the cabin, a cargo area portion of the cabin, and the like). The sensing system 11 includes an electronic control unit (ECU) that includes a data processor that is operable to process data captured by the radar sensor(s).

The radar sensor may include a plurality of transmitters that transmit radio signals via a plurality of antennas. The radar sensor may also include a plurality of receivers that receive radio signals via the plurality of antennas. The received radio signals are transmitted radio signals that are reflected from an object. The ECU or processor is operable to process the received radio signals to sense or detect the object that the received radio signals reflected from.

The radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas. The ECU or sensing system 11 may be part of a driving assist system of the vehicle, with the driving assist system controlling at least one function or feature of the vehicle (such as to provide autonomous driving control of the vehicle) responsive to processing of the data captured by the radar sensors. For example, the driving assist system may determine attentiveness or distraction of the driver based on detection of objects within the cabin of the vehicle. The data transfer or signal communication from the sensor to the ECU may comprise any suitable data or communication link, such as a vehicle network bus or the like of the equipped vehicle.

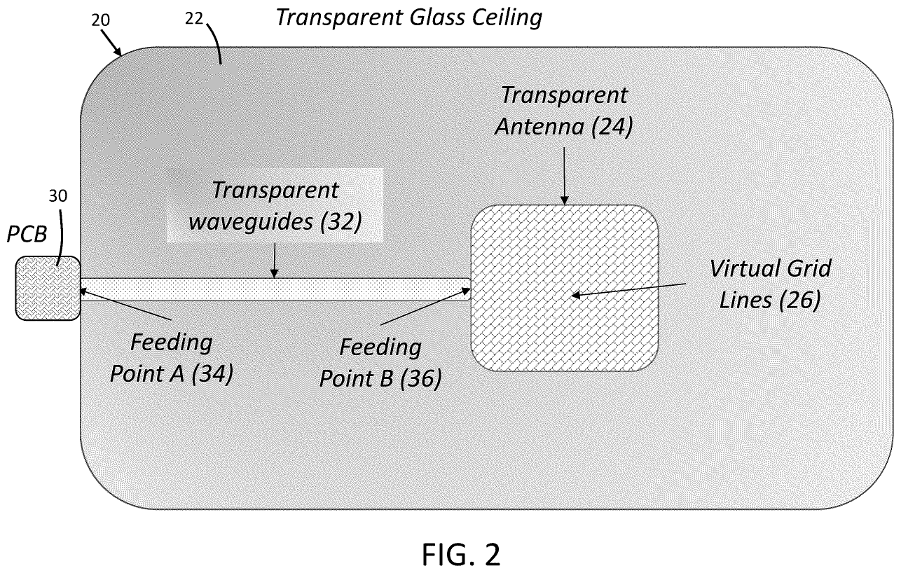

As discussed further below, the radar sensor 20 may include or be integrated with a transparent (or substantially transparent) substrate 22, such as glass panel of the vehicle (e.g., a sunroof or moonroof or panoramic glass roof panel, a side window panel, a rear window panel, a front windshield and the like) with antennas and/or other components of the radar sensor substantially transparent so as to hide or render covert the radar sensor at the glass panel 22 (FIG. 2). That is, the transparent radar sensor 20 includes one or more antennas 24 disposed at the transparent substrate 22 and that are transparent or substantially transparent or not readily visible to occupants of the vehicle. In the illustrated example, the antenna 24 includes a mesh or grid 26 of conductive material disposed at the transparent substrate 22, where the transparent antenna 24 for the radar sensor 20 may be etched or otherwise formed in the sunroof, which is substantially transparent to visible light (e.g., light within the visible range of the electromagnetic spectrum, such as light having wavelengths greater than about 400 nanometers and less than about 700 nanometers). Further, the radar sensor 20 includes a printed circuit board (PCB) 30 that generates radio frequency (RF) signals and/or processes received RF signals. That is, the PCB 30 may accommodate the transmitters and receivers of the radar sensor that respectively transmit radio wave signals to the antenna 24 and receive radio wave signals from the antenna 24 for generating and processing the RF signals. The PCB 30 is disposed away from the transparent substrate 22 (such as at or near or along an edge region of the glass panel) and a transparent waveguide or connector 32 extends between the PCB 30 and the antenna 24 along the transparent substrate 22.

In other words, the present disclosure provides a transparent antenna for a radar system, and which can be etched or otherwise manufactured into a glass surface, while keeping the glass transparent to the visible light spectrum. In some embodiments, the transparent antenna may include a nano mesh conductor embedded into the glass, which can be fed by the transparent waveguide.

In some embodiments, the transparent antenna may include a reflector. For example, a piece of glass can be coated by coating a transparent conductive metal (TCM) film, which may be fed by a streaming RF beam. That is, the transparent antenna may include a layer or coating of transparent conductive material, such as the TCM film, disposed at the transparent substrate. The TCM film may be disposed on the substrate, such as glass, SrLaAlO₄ (SLAO), and/or (LaAlO₃)+ (Sr₂AlTaO₆) (LSAT). In some examples, the LSAT of the substrate may include three parts of LaAlO₃ per seven parts of Sr₂AlTaO₆. The TCM film may include Perovskite oxide (SrVO₃). Alternatively or additionally, the TCM film may include Calcium Vanadium oxide (CaVO₃). The TCM film may have a thickness of between about 4 nanometers and 45 nanometers. However, the TCM film may be thinner than 4 nanometers or thicker than 45 nanometers.

The reflector may include any suitable layer or coating of transparent electrically conductive material disposed at the substrate. For example, the reflector may include an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, such as by utilizing aspects of the systems and devices described in U.S. Pat. No. 7,274,501, which is hereby incorporated herein by reference in its entirety). Optionally, the reflector may include one or more transparent semi-conductive layers (such as an ITO layer or the like), and one or more metallic electrically conductive layers (such as a layer of silver, aluminum, chromium or the like or an alloy thereof), and may include multiple layers such as by utilizing aspects of the systems and devices described in U.S. Pat. Nos. 8,730,553; 8,508,831; 7,626,749; 7,274,501; 7,184,190; 7,255,451 and/or 5,066,112, which are hereby incorporated herein by reference in their entireties.

The transparent antennas and/or reflectors may be used to transmit and receive RF signals in a specific bandwidth and to provide data about detected objects, such as distance, speed, elevation, motion and the like. The transparent antennas and/or reflectors may be made by etching or otherwise forming microwires into a substrate of glass, where the conductive and transparent mesh is forming the antenna.

The transparent antenna 24 may then be connected to the PCB 30 that contains electronics, such as transmitter devices and/or receiver devices for generating and/or processing the RF signals. That is, the PCB 30 may function as a feeder to supply the RF energy to the antenna 24. The PCB 30 may be located in any suitable position relative to the antenna 24, such as at or near an edge region of the glass substrate 22. For example, the PCB 30 may be disposed at or behind a non-transparent portion of the substrate or at or behind a non-transparent portion of the interior cabin of the vehicle near the transparent substrate 22, such as a body panel or door panel or headliner or the like, so as to be hidden from view of the vehicle occupants. Optionally, the PCB 30 may be disposed remote from the transparent substrate 22, such as at a dashboard of the vehicle, at a pillar(s) of the vehicle, or in a rearview mirror assembly of the vehicle. A coaxial cable may be used to connect the PCB 30 to the transparent antenna 24. The length of the coaxial cable may be critical to prevent signal loss and integrity. Optionally, the transparent waveguide 32 may provide a reliable connection between the PCB electronics and the antenna 24. In some examples, the glass sunroof may function as a reflector for reflecting the RF energy. Optionally, the TCM film layer may function as the reflector.

FIG. 1 shows an overhead view of the vehicle 10 with four occupants 12, and with the transparent radar sensor system 20. The transparent radar sensor system 20 may be configured to sense portions or regions of the interior cabin of the vehicle corresponding to positions of the occupants 12. For example, the antenna 24 may be positioned at a central portion of the sunroof to sense the front driver region, the front passenger region, and the rear passenger regions of the interior cabin. Optionally, the radar sensor system 20 may include multiple antennas for sensing respective portions of the interior cabin, such as a first antenna for sensing the front passenger portions and a second antenna for sensing the rear passenger portions and/or a cargo area portion of the cabin.

FIG. 2 shows a schematic diagram of the transparent radar sensor system 20. The transparent radar sensor system 20 may be used as a sunroof or a transparent roof panel in the vehicle. The transparent radar sensor system 20 includes the substrate 22 of material transparent to visible light and the substrate 22 may include glass. Optionally, the substrate may include a laminate structure (e.g., a laminate glass panel or substrate). For example, the antenna 24 and/or reflector and the waveguide 32 may be disposed between panels of the laminate glass substrate. The transparent radar sensor system 20 also includes the transparent antenna 24 formed from the mesh 26 of conductive material disposed within or upon the substrate 22. The transparent antenna 24 may be transparent, or substantially transparent, to visible light. The mesh 26 may include, for example, a grid of wires 26.

The transparent radar sensor system 20 also includes the PCB 30 that includes circuitry for generating the RF energy and/or for receiving and processing RF energy from the transparent antenna 24. The PCB 30 is connected to the transparent antenna 24 via the transparent waveguide 32. The transparent waveguide 32 may be disposed upon or within the substrate 22 and may be substantially transparent to visible light. The transparent waveguide 32 is connected to the PCB 30 at a first feeding point 34. The transparent waveguide 32 is connected to the transparent antenna 24 at a second feeding point 36.

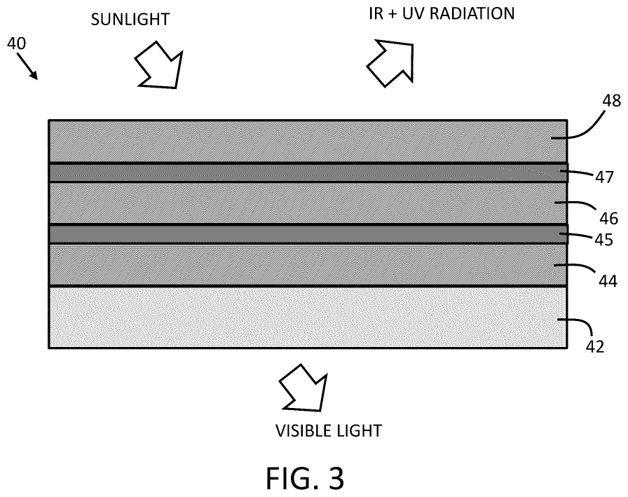

FIG. 3 shows a cross-section diagram of a structure 40 that is transmissive to at least a portion of visible light incident at the structure 40 and that reflects at least a portion of ultraviolet (UV) and infrared (IR) radiation incident at the structure 40. For example, the structure 40 may be transmissive to a larger portion of visible light incident at the structure 40 (such as 90 percent or more, 95 percent or more, 99 percent or more, and the like) and may be transmissive to a smaller portion of UV and IR radiation incident at the structure 40 (such as 90 percent or less, 50 percent or less, 25 percent or less 5 percent or less, and the like). The structure 40 may reflect at least a portion of RF energy incident at the structure 40 (such as 25 percent or more, 50 percent or more, 90 percent or more, and the like). The structure 40 may be used for or as a part of the substrate 22 of the transparent radar sensor system 20.

The structure 40 includes a base layer 42, which may include a polymer such as Polyethylene terephthalate (PET). The structure 40 includes a first Zinc Oxide layer 44 overlying the base layer 42 and which includes Zinc Oxide (ZnO). The structure 40 also includes a first metalized layer 45 that overlies the first Zinc Oxide layer 44. The first metalized layer 45 may include copper-doped silver. The structure 40 also includes a second Zinc Oxide layer 46 overlying the first metalized layer 45 and which includes ZnO. The structure 40 also includes a second metalized layer 47 that overlies the second Zinc Oxide layer 46. The second metalized layer 47 may include copper-doped silver. The structure 40 also includes a third Zinc Oxide layer 48 overlying the second metalized layer 47 and which includes ZnO. Thus, the structure 40 includes the base polymer layer 42 and one or more zinc oxide layers and metalized layers. The zinc oxide layers and metalized layers may be alternatingly disposed at the structure.

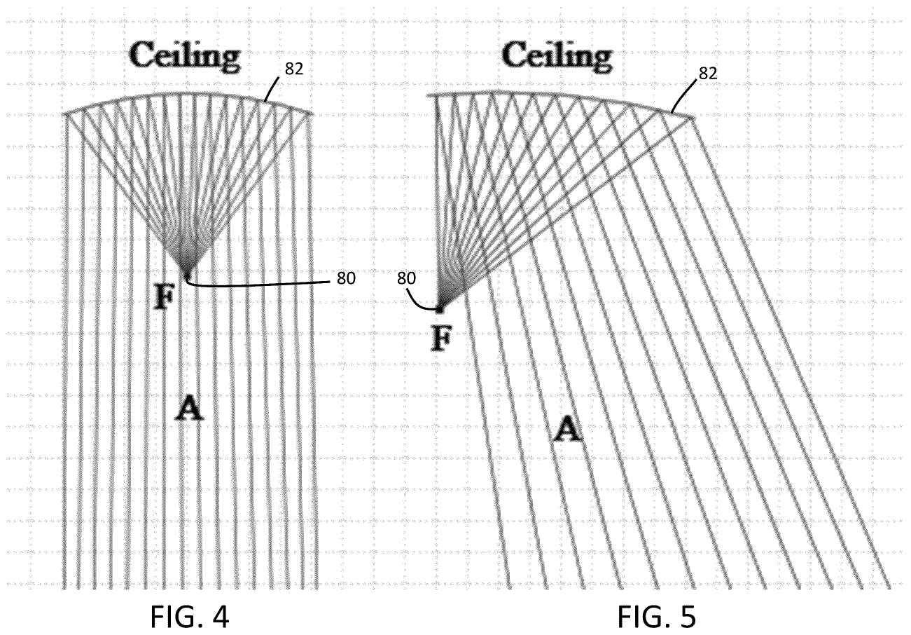

FIGS. 4 and 5 each show diagrams of radar emanating from a source 80 at a focal point F and reflecting off of a reflector 82 to define an effective area A, which may also be called an aperture. The reflector 82 may be formed in a ceiling of the vehicle and the radar antenna radiating the RF energy may be disposed at or near or below the reflector 82, such as within the ceiling of the vehicle or at another interior portion of the cabin of the vehicle. In some examples, the transparent roof of the vehicle may include the reflector 82 and/or the antenna. The reflector 82 may include the structure 40 for reflecting the RF energy incident thereat. FIG. 4 shows the effective area A extending downwardly and back toward the source 80. That is, the source 80 may be disposed below the reflector 82 and generates the RF energy such that the RF energy emanates in a radial array from the source 80 and the reflector 82 may be configured to reflect at least a portion of the RF energy downward and toward the source 80. The arrangement of FIG. 4 may be called an axial feed system. FIG. 5 shows the effective area A extending downwardly and offset from the source 80. In other words, the source 80 may be disposed below the reflector 82 and radiates the RF energy such that the RF energy emanates in a radial array from the source 80 and the reflector 82 may be configured to reflect at least a portion of the RF energy downward and away from the source 80. The arrangement of FIG. 5 may be called an off-axis feed system.

Thus, the transparent reflector may be disposed at the transparent substrate and the antenna or source may be disposed at the interior portion of the cabin of the vehicle and inboard of the transparent reflector. For example, the antenna may be disposed at the sunroof and below the reflector or at the window panel and inboard of the reflector. Optionally, the antenna is at another interior portion of the vehicle at or near the transparent reflector, such as a door panel, headliner, light module (e.g., a reading light module or dome light module), door handle module, and the like. When the radar sensor is operated to generate the RF energy, the RF energy radiates from the antenna and the RF energy is reflected from the reflector and toward the antenna and the interior portion of the cabin. For example, the reflector may direct the RF energy toward specific portions of the cabin of the vehicle such as a driver region, a front passenger region, a rear seat region, a cargo area region, and the like.

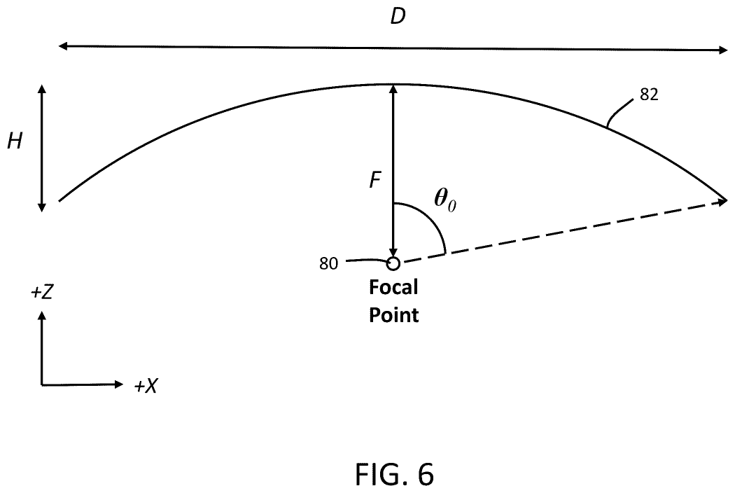

FIG. 6 shows a schematic diagram of a radar reflector 82 with a parabolic shape. The parabolic shape of the reflector 82 may be described by a diameter D and a focal length F and in accordance with equations (1)-(2):

$$\frac{F}{D} = \frac{1}{4 tan ( {θ}_{0} / 2 )} \qquad ( 1 )$$

$$F = \frac{{D}^{2}}{16 H} \qquad ( 2 )$$

A maximum gain Gₘₐₓ of the reflector 82 may be provided in terms of a physical area of the aperture A, as set forth in equation (3):

$${G}_{max} = \frac{4 π}{{λ}^{2}} A = \frac{{( π D )}^{2}}{{λ}^{2}} \qquad ( 3 )$$

An actual gain G may be related to the physical area by an efficiency term &, and may be described by equation (4).

$$G = ε \frac{4 π}{{λ}^{2}} A = ε \frac{{( π D )}^{2}}{{λ}^{2}} \qquad ( 4 )$$

The efficiency term & may be described as a product of a series of terms, as set forth in equation 5:

$$ε = {ε}_{r} {ε}_{AT} {ε}_{S} {ε}_{O} \qquad ( 5 )$$

where εᵣ is a radiation efficiency of the reflector 82; ε_{AT} is an aperture radiation efficiency that describes uniformity of an E-field across the reflector 82; εₛ is a spillover efficiency that describes an amount of radiation from the source 80 that is reflected by the reflector 82; and εₒ is a parameter that describes other real-world effects, such as surface errors in the reflector 82, cross-polarization, aperture blockage, and the like.

Thus, the vehicular sensing system 11 includes one or more radar sensor modules 20 configured to sense objects and/or occupants within at least a portion of the interior cabin of the vehicle. At least a portion of the radar sensor may be substantially transparent to visible light. That is, the portion of the radar sensor may be transmissive to at least a portion of visible light incident thereat (e.g., 90 percent or more, 95 percent or more, 99 percent or more, and the like). Thus, the transparent portion may be disposed at the transparent substrate 22, such as the glass window panel or roof panel of the vehicle. The transparent portion may comprise the antenna 24, the waveguide 32, and/or the reflector of the radar sensor system. That is, RF energy may be generated and emitted from the transparent portion of the radar sensor system at the transparent substrate. Optionally, the RF energy may be generated and emitted remote from the transparent substrate (such as from the antenna at an interior portion of the cabin of the vehicle like a pillar or door panel or lighting module) and the reflector 82 at the transparent substrate may reflect the RF energy within the vehicle. Based on sensing of RF energy at the antenna of the radar sensor, the system generates sensor data representative of objects and/or occupants within the cabin of the vehicle.

For example, the radar antenna includes a substrate of a material that is transparent to or at least partially or substantially transmissive of visible light incident thereat. A mesh of conductive material is disposed within or upon the substrate. The radar antenna, including the substrate and the mesh of conductive material, appears to be substantially transparent to a human viewer.

The substrate may include glass or a polymer, such as polyethylene terephthalate (PET). For example, the substrate may include a sunroof disposed within a roof of a vehicle. Optionally, the substrate includes SLAO and/or LSAT. For example, the LSAT may include three parts LaAlO₃ per seven parts Sr₂AlTaO₆.

Optionally, the mesh of conductive material is embedded within the substrate. The radar antenna may further include a waveguide configured to transmit electromagnetic radiation to the mesh of conductive material. The waveguide is transparent to visible light.

In some examples, the radar antenna further includes a transparent conductive metal (TCM) film disposed on the substrate and configured to reflect radar energy to the mesh of conductive material. The TCM film may include perovskite oxide (SrVO₃) and/or calcium vanadium oxide (CaVO₃).

A radar reflector may include a substrate of material transparent to visible light. A transparent conductive metal (TCM) film is disposed on the substrate and configured to reflect radar energy. The radar reflector, including the substrate and the TCM film appears to be substantially transparent to a human viewer. The TCM film may include perovskite oxide and/or calcium vanadium oxide. The substrate may include a sunroof disposed within a roof of a vehicle. Optionally, the substrate may include PET, SLAO, and/or LSAT.

The antenna (hardware) forms an essential element of the radar system, which also includes electronics and software. Therefore, for the system to operate correctly, both the antenna and the electronics must be configured to work together.

The systems and antennas of the present disclosure provide several advantages over conventional systems and devices. For example, the transparent radar antenna and/or reflector may be mounted in a ceiling and/or a sunroof of the vehicle, and used for in-cabin monitoring. The transparent radar antenna and/or reflector may remain invisible or hidden. This allows for the radar antenna to be mounted in optimal positions for monitoring the occupants and/or interior spaces of the cabin without compromising visibility through glass panels or windows and/or affecting aesthetic qualities of the vehicle cabin. The system using the transparent radar antenna and/or reflector may be used to replace camera systems that may otherwise be used for monitoring driving state of health. Radar systems may be preferable to camera-based systems due to privacy concerns that arise with camera systems. In some examples, the transparent radar antenna and/or reflector may be located at or near a center of the ceiling, and the transparent waveguide may transmit RF energy to/from the transparent antenna. In case of a reflector, it may be integrated with the ceiling or the roof of the vehicle, and the feed could be located elsewhere, such as on the dashboard. The transparent radar antenna and/or reflector may enable integration of a high-performance radar, while keeping the associated hardware components compact to fit within a limited space.

Further, the systems and antennas may bring comfort to most customers especially when it comes to privacy. The system that includes the transparent radar antenna and/or reflector may be a selling point for customers attracted to new technological products. The transparent radar antenna and/or reflector may provide a cost-effective solution to the various sensing applications for which it may be used.

Moreover, the radar antennas may provide a relatively high viewing angle to the entire vehicle from inside, reducing the number of antennas required to provide coverage of a given area. The radar antennas may be employed in systems that require less data signal processing than is needed for optical (i.e., camera-based) sensing techniques. Configuration tools are available to configure radar sensors for most applications. The radar antennas may be used for several different applications including, for example, vital sign detections, child presence, intrusion detections, seat belt alert system, and the like. Transparent waveguides, such as optical fibers may act as an ideal medium to transport electromagnetic (EM) energy between the radar and the transparent antenna, reducing the challenges as well as complexity of transparent waveguides.

In between the radar and the radiator there may be a coaxial cable for transmitting and receiving RF signals from and to the antenna. The transparent waveguide may be provided to replace the coax cable.

The system may utilize sensors, such as radar sensors or imaging radar sensors or lidar sensors or the like, to detect presence of and/or range to objects and/or other vehicles and/or pedestrians and/or vehicle occupants. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The ECU may be operable to process data for at least one driving assist system of the vehicle. For example, the ECU may be operable to process data (such as image data captured by a forward viewing camera of the vehicle that views forward of the vehicle through the windshield of the vehicle and the ECU may also or otherwise process radar data captured by the radar sensor of the vehicle or other data captured by other sensors of the vehicle (such as other cameras or radar sensors or such as one or more lidar sensors of the vehicle)) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may process captured data for an autonomous control system of the vehicle that controls steering and/or braking and/or accelerating of the vehicle as the vehicle travels along the road.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,582,425; 11,518,401; 10,958,830; 10,065,574; 10,017,114; 9,405,120 and/or 7,914,187, and/or U.S. Publication Nos. US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. patent application Ser. No. 18/535,183, filed Dec. 11, 2023 (Attorney Docket MAG04 P5021), and/or U.S. provisional application Ser. No. 63/641,574, filed May 2, 2024 (Attorney Docket DON01 P5156), and/or International Publication Nos. WO 2023/220222; WO 2022/241423; WO 2022/187805 and/or WO 2023/034956, which are all hereby incorporated herein by reference in their entireties.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular radar sensing system, the vehicular radar sensing system comprising:
a radar sensor disposed at a vehicle, wherein the radar sensor senses within an interior cabin of the vehicle;
wherein the radar sensor comprises an antenna, and wherein the antenna (i) radiates radio frequency signals within the interior cabin of the vehicle and (ii) receives radio frequency signals from within the interior cabin of the vehicle;
wherein the radar sensor comprises a printed circuit board (PCB) comprising electronic circuitry and associated software;
wherein the electronic circuitry comprises a transmitter that transmits radio frequency signals to the antenna and a receiver that receives radio frequency signals from the antenna;
wherein the radar sensor is operable to capture radar data based on the radio frequency signals received at the receiver;
wherein the electronic circuitry of the PCB comprises a processor operable to process radar data captured by the radar sensor;
wherein the vehicular radar sensing system, via processing radar data captured by the radar sensor, determines presence of an occupant within the interior cabin of the vehicle; and
wherein the antenna is disposed at a portion of a substrate of the vehicle, and wherein the portion of the substrate is at least partially transmissive of visible light incident at the portion of the substrate.

2. The vehicular radar sensing system of claim 1, wherein the radar sensor comprises a waveguide that transmits the radio frequency signals from the transmitter to the antenna and that transmits the radio frequency signals from the antenna to the receiver, and wherein at least a portion of the waveguide is disposed at the substrate, and wherein the portion of the waveguide is at least partially transmissive of visible light incident at the portion of the waveguide.

3. The vehicular radar sensing system of claim 1, wherein the antenna comprises a mesh of electrically conductive material.

4. The vehicular radar sensing system of claim 3, wherein the mesh of electrically conductive material is at least partially embedded within the substrate.

5. The vehicular radar sensing system of claim 3, wherein the mesh of electrically conductive material is etched into the substrate.

6. The vehicular radar sensing system of claim 3, wherein the mesh of electrically conductive material is disposed between a first layer of the substrate and a second layer of the substrate.

7. The vehicular radar sensing system of claim 1, wherein the antenna comprises an electrically conductive film disposed at the substrate, and wherein the electrically conductive film is at least partially transmissive of visible light incident at the electrically conductive film.

8. The vehicular radar sensing system of claim 1, wherein the substrate comprises a glass panel of the vehicle.

9. The vehicular radar sensing system of claim 8, wherein the glass panel comprises one selected from the group consisting of (i) a sunroof of the vehicle, (ii) a moonroof of the vehicle, (iii) a panoramic glass roof of the vehicle, (iv) a front windshield of the vehicle and (v) a window of the vehicle.

10. The vehicular radar sensing system of claim 1, wherein the substrate comprises a polymeric panel of the vehicle.

11. The vehicular radar sensing system of claim 10, wherein the polymeric panel comprises polyethylene terephthalate (PET).

12. The vehicular radar sensing system of claim 1, wherein the substrate comprises SrLaAlO₄ (SLAO).

13. The vehicular radar sensing system of claim 1, wherein the substrate comprises LaAlO₃+Sr₂AlTaO₆ (LSAT).

14. The vehicular radar sensing system of claim 13, wherein the LSAT comprises three parts LaAlO₃ per seven parts Sr₂AlTaO₆.

15. The vehicular radar sensing system of claim 1, wherein a reflector is disposed at the substrate, and wherein the reflector reflects radio frequency signals radiated by the antenna toward the interior cabin of the vehicle, and wherein the reflector reflects radio frequency signals from within the interior cabin of the vehicle toward the antenna, and wherein the reflector is at least partially transmissive of visible light incident at the reflector.

16. The vehicular radar sensing system of claim 15, wherein the reflector comprises a transparent electrically conductive metal film.

17. The vehicular radar sensing system of claim 16, wherein the transparent electrically conductive metal film comprises at least one of the group consisting of (i) perovskite oxide (SrVO₃) and (ii) vanadium oxide (CaVO₃).

18. The vehicular radar sensing system of claim 1, wherein the PCB is disposed at the vehicle and spaced from the substrate.

19. A vehicular radar sensing system, the vehicular radar sensing system comprising:
a radar sensor disposed at a vehicle, wherein the radar sensor senses within an interior cabin of the vehicle;
wherein the radar sensor comprises an antenna, and wherein the antenna (i) radiates radio frequency signals within the interior cabin of the vehicle and (ii) receives radio frequency signals from within the interior cabin of the vehicle;
wherein the radar sensor comprises a printed circuit board (PCB) comprising electronic circuitry and associated software;
wherein the electronic circuitry comprises a transmitter that transmits radio frequency signals to the antenna and a receiver that receives radio frequency signals from the antenna;
wherein the radar sensor is operable to capture radar data based on the radio frequency signals received at the receiver;
wherein the electronic circuitry of the PCB comprises a processor operable to process radar data captured by the radar sensor;
wherein the radar sensor comprises a reflector, and wherein the reflector reflects radio frequency signals radiated by the antenna toward the interior cabin of the vehicle, and wherein the reflector reflects radio frequency signals from within the interior cabin of the vehicle toward the antenna;
wherein the vehicular radar sensing system, via processing radar data captured by the radar sensor, determines presence of an occupant within the interior cabin of the vehicle; and
wherein the reflector is disposed at a portion of a substrate of the vehicle, and wherein the portion of the substrate is at least partially transmissive of visible light incident at the portion of the substrate, and wherein the reflector is at least partially transmissive of visible light incident at the reflector.

20. The vehicular radar sensing system of claim 19, wherein the antenna is disposed at another portion of the substrate, and wherein the other portion of the substrate is at least partially transmissive of visible light incident at the other portion of the substrate.

21. The vehicular radar sensing system of claim 20, wherein the antenna comprises a mesh of electrically conductive material.

22. The vehicular radar sensing system of claim 20, wherein the antenna comprises an electrically conductive metal film disposed at the substrate, and wherein the electrically conductive metal film is at least partially transmissive of visible light incident at the electrically conductive film.

23. The vehicular radar sensing system of claim 19, wherein the substrate comprises a glass panel of the vehicle.

24. The vehicular radar sensing system of claim 19, wherein the substrate comprises a polymeric panel of the vehicle.

25. The vehicular radar sensing system of claim 19, wherein the reflector comprises a transparent electrically conductive metal film.

26. A vehicular radar sensing system, the vehicular radar sensing system comprising:
a radar sensor disposed at a vehicle, wherein the radar sensor senses within an interior cabin of the vehicle;
wherein the radar sensor comprises an antenna, and wherein the antenna (i) radiates radio frequency signals within the interior cabin of the vehicle and (ii) receives radio frequency signals from within the interior cabin of the vehicle;
wherein the radar sensor comprises a printed circuit board (PCB) comprising electronic circuitry and associated software;
wherein the electronic circuitry comprises a transmitter that transmits radio frequency signals to the antenna and a receiver that receives radio frequency signals from the antenna;
wherein the radar sensor comprises a waveguide that transmits the radio frequency signals from the transmitter to the antenna and that transmits the radio frequency signals from the antenna to the receiver;
wherein the radar sensor is operable to capture radar data based on the radio frequency signals received at the receiver;
wherein the electronic circuitry of the PCB comprises a processor operable to process radar data captured by the radar sensor;
wherein the vehicular radar sensing system, via processing radar data captured by the radar sensor, determines presence of an occupant within the interior cabin of the vehicle;
wherein the antenna is disposed at a portion of a vehicular window panel of the vehicle, and wherein the portion of the vehicular window panel is at least partially transmissive of visible light incident at the portion of the vehicular window panel; and
wherein at least a portion of the waveguide is disposed at the vehicular window panel, and wherein the portion of the waveguide is at least partially transmissive of visible light incident at the portion of the waveguide.

27. The vehicular radar sensing system of claim 26, wherein the antenna comprises a mesh of electrically conductive material.

28. The vehicular radar sensing system of claim 27, wherein the mesh of electrically conductive material is etched into the vehicular window panel.

29. The vehicular radar sensing system of claim 26, wherein the vehicular window panel comprises one selected from the group consisting of (i) a sunroof of the vehicle, (ii) a moonroof of the vehicle, (iii) a panoramic glass roof of the vehicle, (iv) a front windshield of the vehicle and (v) a window of the vehicle.

30. The vehicular radar sensing system of claim 26, wherein a reflector is disposed at the vehicular window panel, and wherein the reflector reflects radio frequency signals radiated by the antenna toward the interior cabin of the vehicle, and wherein the reflector reflects radio frequency signals from within the interior cabin of the vehicle toward the antenna, and wherein the reflector is at least partially transmissive of visible light incident at the reflector.
